(19) United States
(12) Patent Application Publication
(10) Pub. No.: US 2020/0170451 A1
(43) Pub. Date: Jun. 4, 2020

(54) CULINARY CHOPPING BOARD

(71) Applicant: Spencer Donald Stadnek, Prince Albert (CA)

(72) Inventor: Spencer Donald Stadnek, Prince Albert (CA)

(21) Appl. No.: 16/208,537

(22) Filed: Dec. 3, 2018

(51) Int. Cl. A47J 47/00

(52) U.S. Cl. CPC A47J 47/005

(57) ABSTRACT

The present invention provides a culinary chopping board having an upper surface and a lower flat surface. The upper surface further comprises a flat portion which is used for cutting the food items and an inclined portion which is used for transferring the cut food item into the dish. The peripheral edge of the second end of the culinary chopping board is coupled to a peripheral wall for preventing the cut food items to fall off.

### FIELD OF THE INVENTION

The present invention is related to a culinary chopping board and more particularly to a chopping board having an inclined portion for accurately dropping the cut food items into the bowl/dish.

### BACKGROUND OF THE INVENTION

The present invention is related to a culinary chopping board which is well-known in the art. It has been in common use for many years and with course of time there have been many developments to the design, the structure and to the material.

Referring to the course of developments, many changes have been made to the material, from using heavy wood to light weight plastic material. Changes have been made to structure and design from having flat shape to curved shape, from pointed edges to round edges and many more.

The common problem associated with the culinary chopping boards is the transfer of the cut food into the bowl/dish. Usually for cutting the food items the structure of the culinary chopping board is designed as planar. Due to this shape, transferring of the food items becomes difficult as the food items tend to fall off from the culinary chopping board while transferring to bowl/dish.

Presently, there are some prior arts available to solve the above-mentioned problem such as U.S. Pat. Nos. 5,203,548 and 444,705 which are also enabled to dispense a cut food item into the bowl/dish. Both the inventions have at least one side foldable by the hinges. The drawbacks with the hinges of these inventions are that these create a gap between the two foldable portion which leads to uneven surface for cutting the food items. Moreover, during situation of use, the fold created by them can be mishandled by the user which results in the spillage of the food item.

Therefore, there is a need to eliminate the above mentioned prior arts.

### SUMMARY OF THE INVENTION

The present invention is related to a culinary chopping board and more particularly to a chopping board having an inclined portion for accurately dropping the cut food into the bowl.

The present invention provides a culinary chopping board having an upper surface and a lower flat surface. The upper surface further comprises a flat portion which is used for cutting the food items and an inclined portion which is used for transferring the cut food item into the dish. The peripheral edge of the inclined portion is coupled to a peripheral wall for preventing the cut food items to fall off from the culinary chopping board.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the side view of the given invention.

FIG. 2 illustrates the perspective view of the given invention.

### DETAILED DESCRIPTION OF THE INVENTION

Reference will now be made in detail to the exemplary embodiment (s) of the invention. References to “one embodiment,” “at least one embodiment,” “an, embodiment” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation, Further, repeated use of the phrase “in an embodiment” does not necessarily refer to the same embodiment.

The present invention provides a culinary chopping board for easily transferring the cut food item into the dish.

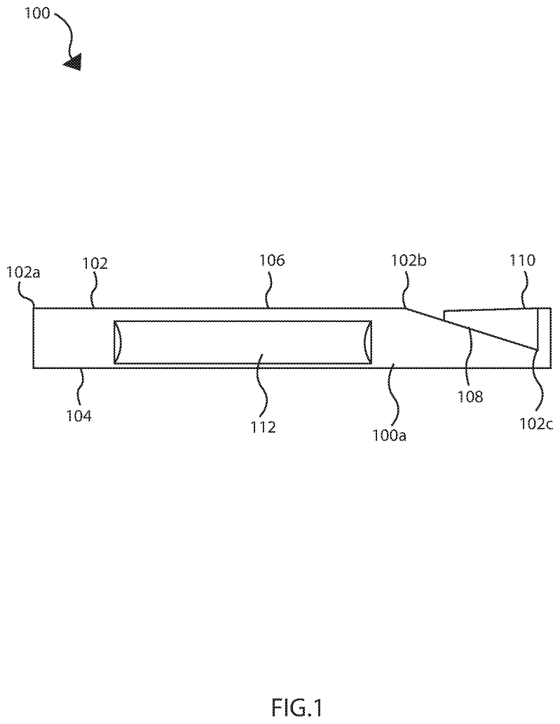

FIG. 1 illustrates the side view of the given invention. The culinary chopping board (100) comprises an upper surface (102) and lower surface (104). The upper surface (102) comprises a flat portion (106) and an inclined portion (108) such that the flat portion (106) is from a first end (102a) of the upper surface (102) to a first location (102b) and an inclined portion (104) is from the first location (102b) of the fiat portion (106) to a second end (102c) of the upper surface (102). The culinary chopping board (100) further comprises a peripheral wall (110) coupled to the second end (102c) of the upper surface (102). The at least one peripheral edge (100a) of the culinary chopping board (100) comprises at least one depression (112) to hold the culinary chopping board (100).

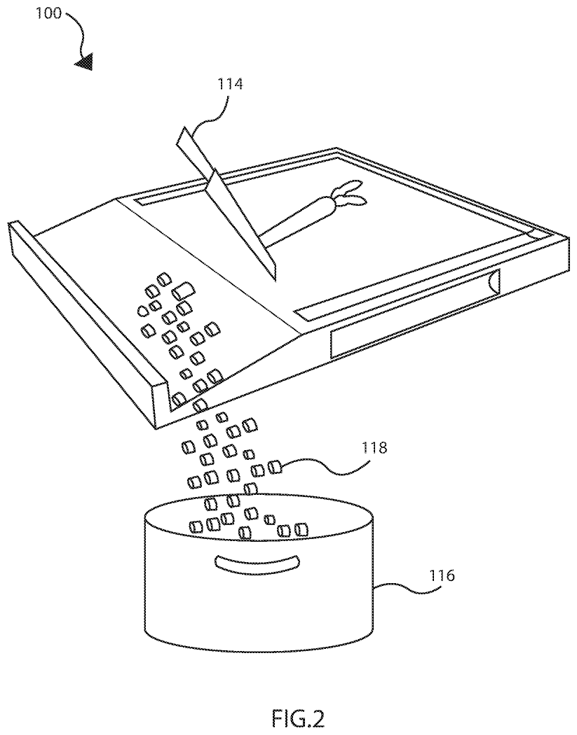

FIG. 2 illustrates the perspective view of the given invention. Herein, the culinary chopping board (100) comprises a knife (114) and a dish (116) for dropping the cut food items (113).

In preferred embodiment, the upper surface (102) of the culinary chopping board (100) is used for cutting the food items (118). The user places and cuts the food item (118) onto the flat portion (106) of the upper surface (102). The flat portion (106) comprises a large portion of the upper surface (102) so that the user is enabled to cut food items (118) with an ease. The cut food items (118) are then transferred to the inclined portion (108) of the upper surface (102) wherein, the peripheral wall (110) coupled to the second end (102c) of the upper surface (102) prevents the cut food items (118) to fall off the culinary chopping board (100) Herein, the peripheral wall (110) is either integrally or is removably coupled to the second end (102c) of the upper surface (102). The user is enabled to lift the culinary chopping board (100) by at least on depression (112) present on the at least one peripheral edge (100a) and tilts the culinary chopping board (100) from its inclined portion (102) towards a dish (116). The user with the help of knife (114) or hand is enabled to easily transfer the cut food items (118) into the dish (116) which prevents the cut food items to spill off the dish (116).

In other embodiment, the circumference of the peripheral edges is coupled to a peripheral wall which is smaller in height to the peripheral wall coupled to the second end the upper surface. The peripheral walls which are either integrally or are removably coupled to the peripheral edges prevent the cut food items to fall off from the culinary chopping board.

In another embodiment, the at least one peripheral edge of the culinary chopping board is coupled to at least one handle for its easy handling.

While the invention has been described in detail with specific reference to preferred embodiments thereof, it is understood that variations and modifications thereof may be made without departing from the true spirit and scope of the invention.

What is claimed is:

1. A culinary chopping board having an upper surface and a lower flat surface, wherein the upper surface comprises a flat portion and an inclined portion, and wherein the flat portion is from a first end of the upper surface to a first location and an inclined portion is from the first location of the flat portion to a second end of the upper surface.

2. The culinary chopping board of claim 1, wherein the second end of the upper surface couples to a peripheral wall.

3. The culinary chopping board of claim 1, wherein peripheral edges of the culinary chopping board is integrally coupled to a peripheral wall.

4. The culinary chopping board of claim 1, wherein the peripheral edges of the culinary chopping board is removably coupled to the peripheral wall.

5. The culinary chopping board of claims 2 & 3, wherein the peripheral wall coupled to the second end of the upper surface is higher than the peripheral wall coupled to the peripheral edges of the culinary chopping board.

6. The culinary chopping board of claim 1, wherein the at least one peripheral edge of the culinary chopping board is coupled to at least one handle.

7. The culinary chopping board of claim 1, wherein the peripheral edges of the culinary chopping board have at least one depression for holding the culinary chopping board.

8. A culinary chopping board having an upper surface and a lower flat surface, wherein the upper surface comprises a fiat portion and an inclined portion, wherein the flat portion is from a first end of the upper surface to a first location and an inclined portion is from the first location of the flat portion to a second end of the upper surface, and wherein the second end of the upper surface is coupled to a peripheral wall.
